(19) United States
(12) Patent Application Publication
(10) Pub. No.: US 2025/0224736 A1
(43) Pub. Date: Jul. 10, 2025

(54) BOUNDARY DEFINING METHOD AND SYSTEM, AND A COMPUTER PROGRAM PRODUCT

(71) Applicant: URSrobot AI Inc., Taipei City (TW)

(72) Inventors: Chien-Tung CHEN, Taipei City (TW); Chung-Hou WU, Taipei City (TW); Chao-Cheng CHEN, Taipei City (TW); Dien-Lin TSAI, Taipei City (TW)

(21) Appl. No.: 19/014,101

(22) Filed: Jan. 8, 2025

(30) Foreign Application Priority Data
Jan. 9, 2024 (TW) 113100872

(51) Int. Cl. G05D 1/646; G05D 1/248; G05D 1/617; G05D 109/10; G05D 111/30

(52) U.S. Cl. CPC G05D 1/646; G05D 1/248; G05D 1/617; G05D 2109/10; G05D 2111/30

(57) ABSTRACT

A boundary defining method implemented by a boundary defining system comprises: (A) obtaining a piece of positioning data that includes a path record and a signal status record, the path record indicating a circling path defining a circled area, the signal status record indicating one or more risky path sections in the circling path that meet a poor signal condition; (B) based on each risky path section indicated by the signal status record, determining an alternative path section corresponding to the risky path section and located within the circled area; and (C) based on at least the alternative path section(s), generating and outputting a piece of operating range data indicating an operating boundary, the operating boundary defining an operating area suitable for automatic movement of an autonomous mobile operation equipment, and that does not include the risky path section(s).

### CROSS-REFERENCE

This application claims priority to Taiwanese Invention Patent Application No. 113100872, filed on Jan. 9, 2024, the entire disclosure of which is incorporated by reference herein.

### TECHNICAL FIELD

The present invention relates to a boundary defining method, and more particularly to a boundary defining method to be implemented using satellite positioning technology. The present invention also relates to a boundary defining system to be implemented using satellite positioning technology, and a computer program product.

### PRIOR ART

In recent years, Autonomous Mobile Robot (AMR) technology has become more mature and applications thereof have become more widespread. Weeding, repelling insects, cleaning, disinfecting, inspecting, transporting, and even crop harvesting, etc., are all within the application scope of AMR.

Before the AMR begins an automated operation, a user often needs to define one or more areas related to the automated operation, such as an operating area for the AMR to automatically move within, and a no-entry area that the AMR needs to actively avoid while automatically moving around. In order to define the aforementioned areas, one approach in the existing technology is for the user to operate a positioning device or equipment with satellite positioning function to circle around an expected area once, allowing the positioning device to continuously position and record the movement path while circling around, and then using the movement path, which presents in a surrounding manner, as a boundary to define the operating area or no-entry area.

However, if there is an error in satellite positioning results, the boundary defined using the above method will be inconsistent with the actual movement path of the positioning device. In other words, the operating area and no-entry area defined using the above method will differ from the actual area circled around by the positioning device due to the error in satellite positioning results. If the AMR performs automated operations based on a boundary with excessive errors, the AMR may move beyond the expected operating range or enter the expected no-entry range, resulting in accidents or danger. Based on the above, the existing technology still has problems to be solved.

### SUMMARY OF INVENTION

Based on the aforementioned problems of the existing technology, an object of the present invention is to provide a boundary defining method that can improve the existing technology.

The boundary defining method of the present invention is implemented by a boundary defining system that includes a positioning unit and a processing unit; the boundary defining method comprising: (A) the processing unit obtaining a piece of positioning data generated by the positioning unit performing positioning according to a satellite signal group, wherein the piece of positioning data includes a path record and a signal status record, the path record indicates a circling path defining a circled area, and the signal status record indicates one or more risky path section(s) in the circling path that meet a poor signal condition; (B) the processing unit, based on each risky path section indicated by the signal status record, determining an alternative path section corresponding to the risky path section and located within the circled area; (C) the processing unit, based on at least the alternative path section(s), generating and outputting a piece of operating range data indicating an operating boundary, wherein the operating boundary defines an operating area suitable for automatic movement of an autonomous mobile operation equipment, and that does not include the risky path section(s).

Based on the aforementioned problems of the existing technology, the present invention also provides another boundary defining method that can improve the existing technology.

The another boundary defining method of the present invention is implemented by a boundary defining system that includes a positioning unit and a processing unit; the boundary defining method comprising: (A) the processing unit obtaining a piece of positioning data generated by the positioning unit performing positioning according to a satellite signal group, wherein the piece of positioning data includes a path record and a signal status record, the path record indicates a surrounding path that defines a surrounded area, and the signal status record indicates one or more concerning path section(s) in the surrounding path that meet a poor signal condition; (B) the processing unit, based on each concerning path section indicated by the signal status record, determining a replacement path section corresponding to the concerning path section and that is located outside the surrounded area; (C) the processing unit, based on at least the replacement path section(s), generating and outputting a piece of prohibited range data indicating a prohibited boundary, wherein the prohibited boundary defines a prohibited area for prohibiting an autonomous mobile operation equipment from entering automatically, and does not include the concerning path section(s).

Based on the aforementioned problems of the existing technology, another object of the present invention is to provide a boundary defining system that can improve the existing technology.

The boundary defining system of the present invention includes a positioning unit and a processing unit electrically connected to the positioning unit. The processing unit is used for: obtaining a piece of positioning data generated by the positioning unit performing positioning according to a satellite signal group, wherein the piece of positioning data includes a path record and a signal status record, the path record indicates a circling path that defines a circled area, and the signal status record indicates one or more risky path section(s) in the circling path that meet a poor signal condition; based on each risky path section indicated by the signal status record, determining an alternative path section corresponding to the risky path section and located within the circled area; based on at least the alternative path section(s), generating and outputting a piece of operating range data indicating an operating boundary, wherein the operating boundary defines an operating area suitable for automatic movement of an autonomous mobile operation equipment, and that does not include the risky path section(s).

Based on the aforementioned problems of the existing technology, the present invention also provides another boundary defining system that can improve the existing technology.

The another boundary defining system of the present invention includes a positioning unit and a processing unit electrically connected to the positioning unit. The processing unit is used for: obtaining a piece of positioning data generated by the positioning unit performing positioning according to a satellite signal group, wherein the piece of positioning data includes a path record and a signal status record, the path record indicates a surrounding path that defines a surrounded area, and the signal status record indicates one or more concerning path section(s) in the surrounding path that meet a poor signal condition; based on each concerning path section indicated by the signal status record, determining a replacement path section corresponding to the concerning path section and located outside the surrounded area; based on at least the replacement path section(s), generating and outputting a piece of prohibited range data indicating a prohibited boundary, wherein the prohibited boundary defines a prohibited area for prohibiting an autonomous mobile operation equipment from entering automatically, and that does not include the concerning path section(s).

Based on the aforementioned problems of the existing technology, still another object of the present invention is to provide a computer program product that can improve the existing technology.

The computer program product of the present invention includes an application program, wherein, when the application program is loaded and run on an electronic device that includes a positioning unit and a processing unit, the application program can enable the electronic device to implement the boundary defining method described in any of the aforementioned implementations.

The effects of the present invention reside in that: in addition to generating a path record indicating a circling path, the positioning unit can also generate a signal status record indicating each risky path section. Moreover, after obtaining the path record and the signal status record, the processing unit can determine the corresponding alternative path section based on each risky path section indicated by the signal status record, and then replace the corresponding risky path section with each alternative path section to generate a piece of operating range data indicating an operating boundary, thereby defining the operating area applicable to the autonomous mobile operation equipment. It is worth mentioning that the operating boundary is equivalent to the result of “shrinking inwardly” each risky path section of the circling path toward the circled area. Thereby, even if a part of the circled area exceeds an ideal target area actually circled around by the positioning unit, the processing unit can still generate an operating boundary that is equivalent to “shrinking inwardly” the risky path sections to define the operating area so that the risk of the operating area exceeding the ideal target area is significantly lower than that of the circled area. In this way, if the operating boundary indicated by the operating range data is used to plan an operating path for the autonomous mobile operation equipment, the autonomous mobile operation equipment exceeding the ideal target area due to errors in the circling path itself can be effectively prevented. Therefore, problems of the existing technology can indeed be improved.

Or, after obtaining the path record and the signal status record, the processing unit can determine the corresponding replacement path section based on each concerning path section indicated by the signal status record, and then replace the corresponding concerning path section with each replacement path section to generate a piece of prohibited range data indicating a prohibited boundary, thereby defining the prohibited area applicable to the autonomous mobile operation equipment. It is worth mentioning that the prohibited boundary is equivalent to the result of “expanding outwardly” from the surrounded area for each concerning path section of the surrounding path. Thereby, even if a part of the surrounded area does not completely cover an ideal exclusion area, the processing unit can still generate a prohibited boundary that is equivalent to “expanding outwardly” the concerning path sections to define the prohibited area so that the risk of the prohibited area not completely covering the ideal exclusion area is significantly lower than that of the surrounded area. In this way, if the prohibited boundary indicated by the prohibited range data is used to plan an operating path for the autonomous mobile operation equipment, the autonomous mobile operation equipment entering the ideal exclusion area due to errors in the surrounding path itself can be effectively prevented. Therefore, problems of the existing technology can indeed be improved.

### BRIEF DESCRIPTION OF DRAWINGS

Other features and effects of the present invention will be apparently presented in the embodying manner with reference to the drawings, in which:

FIG. 1 is a block diagram illustrating a first embodiment of the boundary defining system of the present invention;

FIG. 2 is a flow chart for illustrating how the first embodiment implements an operating boundary defining procedure in a boundary defining method;

FIG. 3 is a schematic diagram illustrating a circling path recorded during the implementation of the operating boundary defining procedure in the first embodiment;

FIG. 4 is a schematic diagram for illustrating how the first embodiment determines, during the implementation of the operating boundary defining procedure, a plurality of corresponding alternative path sections based on a plurality of risky path sections in the circling path;

FIG. 5 is an incomplete partial enlarged schematic diagram used to enlarge a part of FIG. 4 to help clearly illustrate one of the alternative path sections and two connecting path sections determined based on one of the risky path sections in the first embodiment;

FIG. 6 is a flow chart for illustrating how the first embodiment implements a prohibited boundary defining procedure in the boundary defining method;

FIG. 7 is a schematic diagram illustrating a surrounding path recorded during the implementation of the prohibited boundary defining procedure in the first embodiment;

FIG. 8 is a schematic diagram for illustrating how the first embodiment determines, during the implementation of the prohibited boundary defining procedure, a corresponding replacement path section based on a concerning path section in the surrounding path;

FIG. 9 is an incomplete partial enlarged schematic diagram used to enlarge a part of FIG. 8 to help clearly illustrate the replacement path section and two connecting path sections determined based on the concerning path section in the first embodiment;

FIG. 10 is a schematic diagram illustrating an operating boundary determined by implementing the operating boundary defining procedure, and a prohibited boundary determined by implementing the prohibited boundary defining procedure in the first embodiment; and

FIG. 11 is a bock diagram illustrating a third embodiment of the boundary defining system of the present invention.

### DETAILED DESCRIPTION

Before the present invention is described in detail, it should be noted that, unless otherwise specified, “electrically connected” as described in this patent specification is used to describe the “coupled” relationship between computer hardware (e.g., electronic systems, equipment, devices, units, components), and also generally refers to “wired electrical connection” among a plurality of computer hardware that are physically connected to each other through conductors/semiconductor materials, and “wireless electrical connection” that uses wireless communication technology (for example, but not limited to, mobile communications, wireless networks, Bluetooth® and electromagnetic induction, etc.) to achieve wireless data transmission. On the other hand, unless otherwise specified, “electrically connected” as described in this patent specification also generally refers to “direct electrical connection” achieved through direct coupling among a plurality of computer hardware, and “indirect electrical connection” achieved through indirect coupling among a plurality of computer hardware through other computer hardware.

This patent specification provides multiple embodiments of the same creation. Therefore, in the following description, similar elements between different embodiments are represented by the same reference numerals.

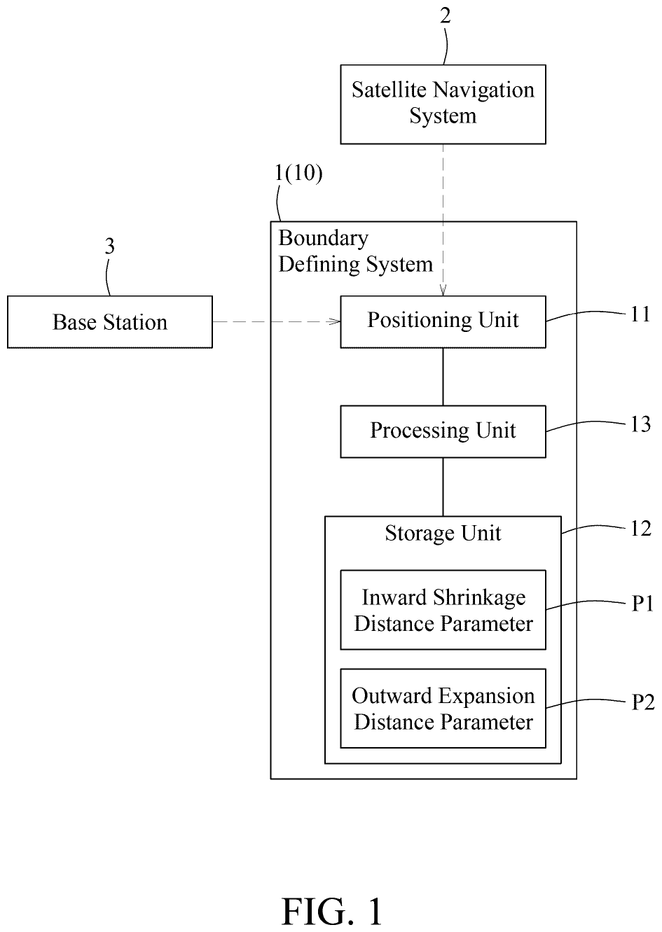

Referring to FIG. 1, the present invention provides a first embodiment of a boundary defining system 1, and the boundary defining system 1 is suitable for cooperating with a satellite navigation system 2 (Global Navigation System, GNSS). More particularly, in an application environment of the present embodiment, the satellite navigation system 2 may be, for example, but not limited to, the Global Positioning System (GPS), the Global Navigation Satellite System (GLONASS), the BeiDou-2 Satellite Navigation System (BDS), the Galileo satellite navigation system (GALILEO), or a combination of more than one of the above systems.

The boundary defining system 1 includes a positioning unit 11, a storage unit 12, and a processing unit 13 electrically connected to the positioning unit 11 and to the storage unit 12.

In the present embodiment, the positioning unit 11 is a Real Time Kinematic (RTK) positioning module implemented using RTK technology, and is configured to receive satellite signals sent by the satellite navigation system 2 and receive reference signals sent by one or more base stations 3 (also called datum stations, fixed stations or reference stations, only one is shown in FIG. 1). Moreover, the positioning unit 11 is used for performing carrier phase difference processing based on the satellite signals and the reference signals, thereby instantly analyzing a current location coordinate of the positioning unit 11 itself and an accuracy of the location coordinate, which means achieving RTK positioning. It should be understood that depending on the location and environment of the positioning unit 11 currently in place, the quantity of the satellite signals that the positioning unit 11 can receive may be different. On the other hand, the positioning unit 11 may not be able to continuously receive the reference signals from the base station 3. In addition, since RTK positioning is an existing technology, details thereof will not be elaborated herein.

In the present embodiment, the storage unit 12 is a data storage device (e.g., a hard disk or other types of computer-readable recording media) for storing digital media. However, in different implementations, the storage unit 12 may also be a cluster of multiple storage devices of the same type or of different types.

In the present embodiment, the processing unit 13 is a processor implemented with an integrated circuit and having functions of data computing and instruction sending and receiving. However, in different implementations, the processing unit 13 can also be a circuit component that includes a processor and a circuit board, or a cluster of multiple processors/processing circuits.

More particularly, in the present embodiment, the boundary defining system 1 is implemented as a boundary defining device 10, which is applicable for defining an autonomous movement range for an autonomous mobile operation equipment (not shown in drawings). In detail, the boundary defining device 10 further includes, for example, a hollow casing, a wheel set equipped on the casing, and a handle connected to the casing (not shown in drawings). Herein, the positioning unit 11, the storage unit 12 and the processing unit 13 are all disposed in the casing. On the other hand, the handle is used for a user to grasp and apply force. Thereby, the user can use the handle to push/pull the boundary defining device 10 to move the boundary defining device 10 on the ground.

If the user wants to use the boundary defining device 10 to define the autonomous movement range for the autonomous mobile operation equipment, the boundary defining device 10 can be operated by the user to circle once around an area expected by the user, and to perform continuous positioning while circling the area, thereby defining an operating area applicable to the autonomous mobile operation equipment. Furthermore, if there exists a section in the aforementioned operating area that needs to be avoided by the autonomous mobile operation equipment, the boundary defining device 10 can also be operated by the user to circle once around the section that needs to be avoided by the autonomous mobile operation equipment, thereby defining a prohibited area applicable to the autonomous mobile operation equipment.

More particularly, the autonomous mobile operation equipment is equivalent to an AMR, and, in the application environment of the present embodiment, the autonomous mobile operation equipment may be, for example, an automatic weeding equipment capable of performing automatic weeding operations. Thus, the aforementioned operating area is, for example, a lawn that needs to be weeded by the autonomous mobile operation equipment, and the aforementioned prohibited area may be, for example, a section of the lawn with obstacles (e.g., buildings, pools or flower beds). However, in different application environments of the present embodiment, the autonomous mobile operation equipment may also be an equipment used for performing different types of lawn maintenance operations (e.g., repelling insects, watering, fertilizing), or an equipment used for automatically performing other specific operations (e.g., cleaning, disinfecting, inspecting). Therefore, the autonomous mobile operation equipment that can be applied in the present embodiment is not limited to automatic weeding equipment.

In the present embodiment, the storage unit 12 stores an inward shrinkage distance parameter P1 and an outward expansion distance parameter P2, wherein the value of the inward shrinkage distance parameter P1 represents a predetermined inward shrinkage distance, and the value of the outward expansion distance parameter P2 represents a predetermined outward expansion distance. For example, the predetermined inward shrinkage distance indicated by the inward shrinkage distance parameter P1 may be, for example, 2 meters, and the predetermined outward expansion distance indicated by the outward expansion distance parameter P2 may be, for example, 0.5 meters. However, it should be understood that the specific values of the predetermined inward shrinkage distance and the predetermined outward expansion distance can be adjusted according to different applications and requirements, and are certainly not limited to the present embodiment.

A boundary defining method implemented by the boundary defining system 1 will be described below.

In the present embodiment, the boundary defining method includes an operating boundary defining process and a prohibited boundary defining process, wherein the operating boundary defining process is used for defining an operating area in which the autonomous mobile operation equipment can move autonomously, and the prohibited boundary defining process is used for defining a prohibited area that the autonomous mobile operation equipment is not allowed to enter. In the application environment of the present embodiment, the prohibited area may be located within the operating area. In other words, the prohibited area may be regarded as an exceptional section of the operating area that the autonomous mobile operation equipment is not allowed to enter.

In more detail, the operating boundary defining procedure is implemented when the positioning unit 11 is operated by the user and circles once around an ideal target area (not shown in drawings), wherein the ideal target area may be, for example, a lawn, and moreover, the ideal target area is an area defined by a path actually traveled by the positioning unit 11, and is equivalent to an area in which the user expects the autonomous mobile operation equipment to automatically operate.

On the other hand, the prohibited boundary defining procedure is implemented when the positioning unit 11 is operated by the user and circles once around an ideal exclusion area, wherein the idea exclusion area is also an area defined by a path actually traveled by the positioning unit 11, and is equivalent to an area that the user expects the autonomous mobile operation equipment to automatically avoid.

It should be added that there is no absolute order of execution between the operating boundary defining process and the prohibited boundary defining process. Moreover, in some implementations, the boundary defining method may only include one of the operating boundary defining process and the prohibited boundary defining process.

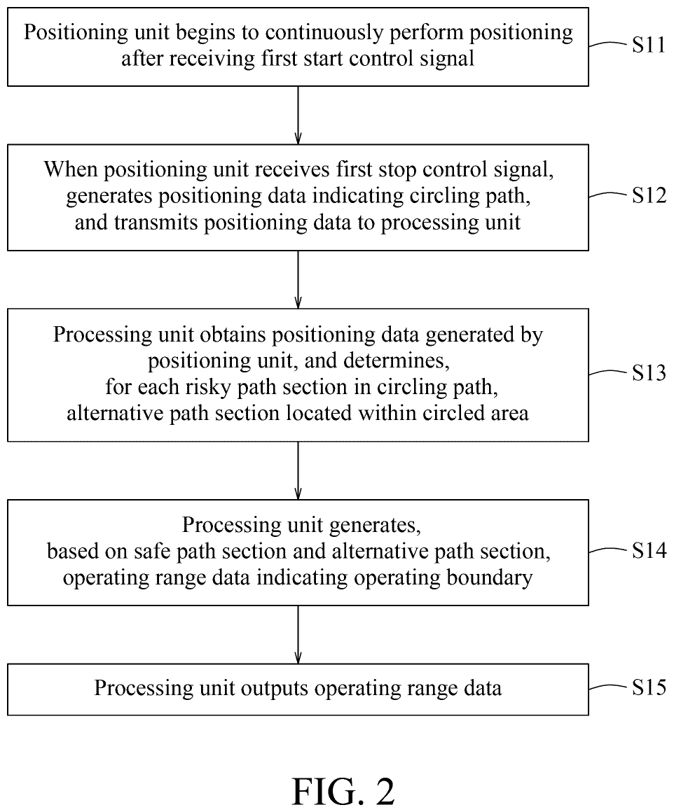

With reference to FIG. 2, how the boundary defining system 1 executes the operating boundary defining procedure will be described below.

First, in step S11, when the positioning unit 11 receives a first start control signal, the positioning unit 11 begins to continuously receive a satellite signal group from the satellite navigation system 2, and continuously performs positioning and records positioning results based on the satellite signal group, wherein the satellite signal group includes one or more satellite signals, and the satellite signals respectively come from multiple satellites included in the satellite navigation system 2. However, it should be understood that as a relative positional relationship between the positioning unit 11 and the satellites changes, the satellite signals included in the satellite signal group may also change. On the other hand, the first start control signal is generated by, for example, the processing unit 13. More specifically, when the user wants to start operating the boundary defining system 1 to circle around the ideal target area, the user can operate the boundary defining system 1 so that the processing unit 13 generates and transmits the first start control signal to the positioning unit 11, thereby controlling the positioning unit 11 to begin continuously performing positioning and recording positioning results.

Specifically, in the present embodiment, the positioning unit 11 uses RTK technology to perform RTK positioning. Therefore, while the positioning unit 11 continuously performs positioning, if the positioning unit 11 receives a reference signal sent by a base station 3, the positioning unit 11 will generate, based on the reference signal and the satellite signal group, a plurality of positioning results (each including a set of positioning coordinates, and the reference signal and the satellite signal corresponding to the set of positioning coordinates). If the positioning unit 11 does not receive the reference signal sent by the base station 3, the positioning unit 11 will generate positioning results only based on the satellite signal group. Specifically, using RTK technology to perform RTK positioning in step S11 includes obtaining, based on the sets of positioning coordinates, a circling path R1 with multiple path sections, and analyzing and determining, based on a preset poor signal condition, one or more risky path sections a1 and one or more safe path sections a2 among the path sections of the circling path R1.

As the positioning unit 11 continuously performs positioning, the process proceeds to step S12.

In step S12, when the positioning unit 11 receives a first stop control signal, the positioning unit 11 stops recording positioning results, generates a piece of positioning data based on all positioning results generated by the positioning unit 11 in step S11, and transmits the piece of positioning data to the processing unit 13. The piece of positioning data includes a path record and a signal status record. The path record includes the sets of positioning coordinates in sequence, and each of the sets of positioning coordinates corresponds to one of the positioning results generated by the positioning unit 11.

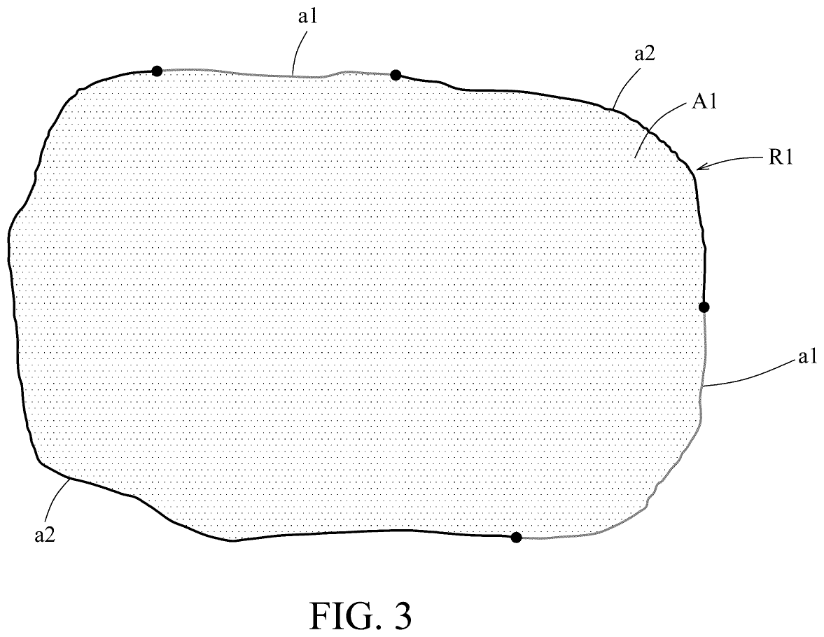

Referring to FIG. 3, the sets of positioning coordinates of the path record jointly indicate the circling path R1, and the circling path R1 defines a circled area A1. It should be noted that the positioning results of the positioning unit 11 may contain errors. Therefore, the circled area A1 and the ideal target area may not necessarily be the same.

Specifically, the signal status record of the piece of positioning data includes a plurality of positioning status codes respectively corresponding to the sets of positioning coordinates, and, for the path sections of the circling path R1, the positioning status codes jointly indicate the one or more risky path sections a1 that meet the poor signal condition, and the one or more safe path sections a2 that “do not” meet the poor signal condition. FIG. 3 exemplarily shows two risky path sections a1 and two safe path sections a2. However, it should be understood that in actual implementation, depending on a positioning situation of the positioning unit 11, the circling path R1 may include only a single or any other number of risky path sections a1 and safe path sections a2, and is not limited to the present embodiment.

In the present embodiment, the poor signal condition includes a first sub-condition and a second sub-condition. When any one of the sub-conditions is met, the poor signal condition is considered as being met. When none of the sub-conditions is met, the poor signal condition is considered as not being met. Using the analysis of one of the path sections as an example, the first sub-condition is that in the satellite signal group corresponding to the sets of positioning coordinates of the path section, the quantity of satellite signals reaching a preset signal strength is less than a threshold (for example, 5, but not limited thereto); the second sub-condition is that the quantity of reference signals corresponding to the sets of positioning coordinates of the path section is 0, that is, the positioning unit 11 did not use any reference signals sent by the base station 3 for positioning.

More specifically, for each of the path sections, the poor signal condition in the present embodiment means that location analysis results of positioning unit 11 for the path section fail to reach a fixed state as defined in RTK positioning technology. For example, if any one of the first sub-condition or the second sub-condition is met, causing the location analysis results of the positioning unit 11 for the path section to only reach a float state with poor accuracy, then the path section will be indicated by the signal status record as a risky path section a1. In other words, each risky path section a1 in the circling path R1 is a collection of positioning results recorded by the processing unit 11 under relatively poor accuracy conditions. Thus, there may be a large offset error between a movement path indicated by each risky path section a1 and an actual movement path of the processing unit 11 when recording the risky path section a1. Therefore, each risky path section a1 may have a section that has exceeded the ideal target area circled around by the positioning unit 11, which means that one or more parts of the circled area A1 exceed the ideal target area.

In an advanced implementation of the present embodiment, the poor signal condition means that any one of the first sub-condition, the second sub-condition or a third sub-condition is met. The third sub-condition means that a delay time length corresponding to the reference signal exceeds a compliance delay time length threshold, wherein the delay time length represents, for example, a length of time from the reference signal being “outputted by the base station 3” to the reference signal being “received by the positioning unit 11”. In other words, the third sub-condition means that the reference signal has a serious delay for the positioning unit 11.

In addition, the first stop control signal is, for example, generated by the processing unit 13. More specifically, when the user has operated the boundary defining system 1 to complete the circling of the ideal target area, the user can operate the boundary defining system 1 so that the processing unit 13 generates and transmits the first stop control signal to the positioning unit 11, thereby controlling the positioning unit 11 to stop recording the positioning results.

After the positioning until 11 transmits the piece of positioning data to the processing unit 13, the process proceeds to step S13.

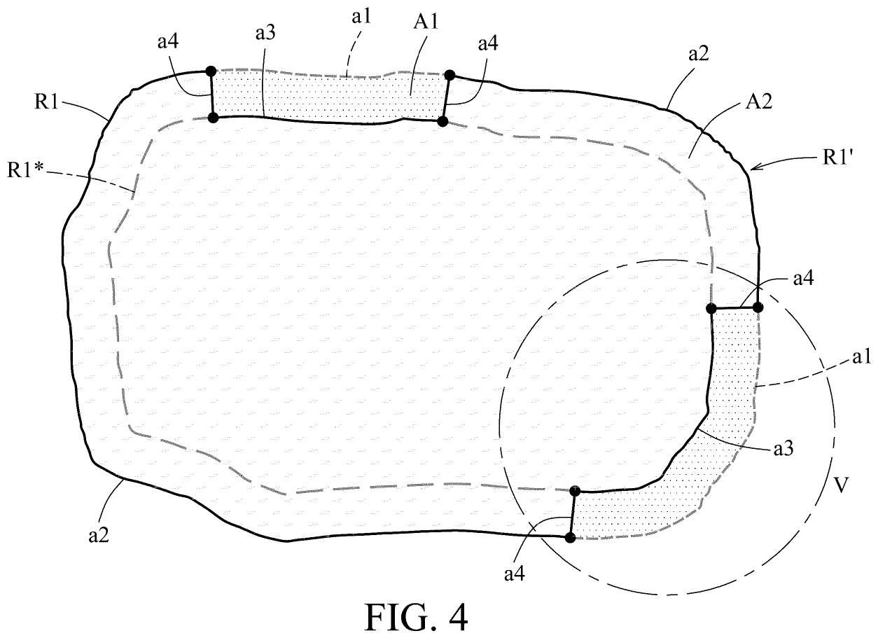

In step S13, with reference to FIG. 4, once the processing unit 13 obtains the piece of positioning data from the positioning unit 11, for each of the risky path sections a1 indicated by the signal status record, the processing unit 13 determines, based on the location of the risky path section a1 and the predetermined inward shrinkage distance indicated by the inward shrinkage distance parameter P1, an alternative path section a3 corresponding to the risky path section a1 and located within the circled area A1. In the present embodiment, each alternative path section a3 and the risky path section a1 corresponding to the alternative path section a3 are equidistantly spaced apart from each other, and a separation distance between the alternative path section a3 and the corresponding risky path section a1 is equal to the predetermined inward shrinkage distance, but is not limited thereto.

More particularly, in the present embodiment, the processing unit 13, for example, first shrinks the circling path R1 according to the predetermined inward shrinkage distance in order to determine an imaginary path R1″ that is located within the circled area A1, that is similar in shape to the circling path R1, and that is equidistantly spaced apart from the circling path R1 by the predetermined inward shrinkage distance. Then, for each of the risky path sections a1, the processing unit 13 extracts from the imaginary path R1″ a section corresponding to the location of the risky path section a1 to be used as the alternative path section a3 corresponding to the risky path section a1.

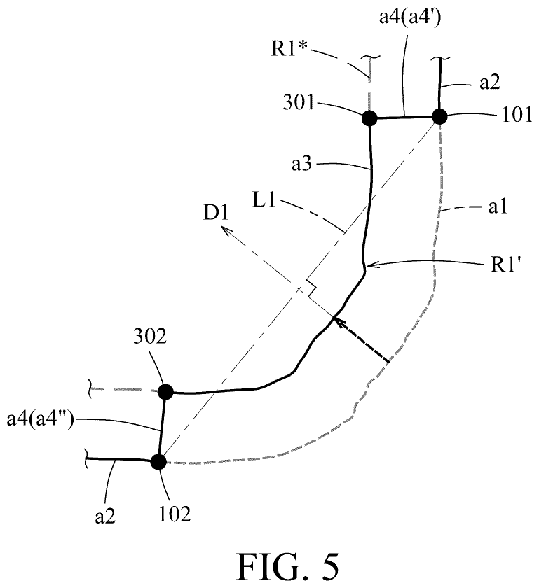

Referring to FIG. 5, using the risky path section a1 shown in FIG. 5 and the corresponding alternative path section a3 thereof as an example, the alternative path section a3 is equivalent to a result of first connecting a terminal end 101 and a terminal end 102 of the risky path section a1 using an imaginary line L1, then shifting the risky path section a1 by the predetermined inward shrinkage distance towards a shrinking direction D1 that is perpendicular to the imaginary line L1, and simultaneously proportionally reducing a length and a width of a track shape of the risky path section a1.

Referring to FIG. 1, FIG. 2 and FIG. 4 at the same time, after the processing unit 13 determines the corresponding alternative path section a3 for each of the risky path sections a1, the process proceeds to step S14.

In step S14, the processing unit 13 generates, based on the safe path sections a2 and the alternative path sections a3, a piece of operating range data indicating an operating boundary R1′. More particularly, in the present embodiment, the processing unit 13 first determines for each alternative path section a3 two connecting path sections a4 corresponding to the alternative path section a3 so that two ends of the alternative path section a3 are each connected to one of the safe path sections a2 through one of the connecting path sections a4. Then, the processing unit 13 generates the operating range data based on all of the safe path sections a2, the alternative path sections a3, and the connecting path sections a4.

Referring to FIG. 5, using the alternative path section a3 and the two connecting path sections a4 shown in FIG. 5 as an example, one connecting path section a4′ of the two connecting path sections a4 is connected between a first end 301 of the alternative path section a3 and a terminal end 101 of the safe path section a2 closest to the first end 301, wherein the terminal end 101 is also equivalent to one end of the risky path section a1 corresponding to the alternative path section a3. On the other hand, one connecting path section a4″ of the two connecting path sections a4 is connected between a second end 302 of the alternative path section a3 and a terminal end 102 of the safe path section a2 closest to the second end 302, wherein the terminal end 102 is also equivalent to the other end of the risky path section a1 corresponding to the alternative path section a3. In regards to another alternative path section a3 and another pair of connecting path sections a4 in FIG. 4 that are not shown in FIG. 5, the connection relationship thereamong is similar to the abovementioned description, therefore will not be described in detail.

Referring again to FIG. 4, it should be noted that the operating boundary R1′ in the present embodiment is composed of all of the safe path sections a2, the alternative path sections a3 and the connecting path sections a4. In other words, the operating boundary R1′ does not include any risky path sections a1. Moreover, the operating boundary R1′ defines an operating area A2 suitable for automatic movement for the autonomous mobile operation equipment. In other words, the operating area A2 is jointly defined by the safe path sections a2, the alternative path sections a3 and the connecting path sections a4. In other embodiments, the alternative path sections a3 generated by the processing unit 13 may also directly connect the terminal end 101 and the terminal end 102 in FIG. 5. That is to say, the processing unit 13 does not necessarily need to generate the connecting path sections a4. Therefore, the operating boundary R1′ can be implemented as long as it includes the safe path section a2 and the alternative path section a3, and does not include the risky path section a1.

Referring to FIG. 3 and FIG. 4 at the same time, it is worth noting that compared to the circling path R1, the operating boundary R1′ is equivalent to the result of making each of the risky path sections a1 in the circling path R1 “shrink” toward the circled area A1. Thereby, even if a section of the circled area A1 adjacent to the risky path section a1 exceeds the ideal target area circled around by the positioning unit 11, the processing unit 13 can still determine the alternative path sections a3 for the risky path sections a1 respectively, which is equivalent to “shrinking inwardly” the risky path sections a1 to generate the operating boundary R1′, whereby the risk of the operating area A2 exceeding the ideal target area will be significantly reduced compared to that of the circled area A1.

After the processing unit 13 generates the operating range data indicating the operating boundary R1′, the procedure proceeds to step S15.

In step S15, the processing unit 13 outputs the operating range data indicating the operating boundary R1′. Specifically, the processing unit 13 outputs the operating range data by, for example, performing one of a first output process, a second output process, and a third output process.

More specifically, the processing unit 13 performs the first output process by outputting the operating range data through a screen in a display manner. That is, the screen is made to display the operating range data in a graphical display manner (e.g., marking the operating boundary R1′ on an electronic map), so as to facilitate the user to browse the operating boundary R1′ and the operating area A2 in conjunction with the electronic map, wherein the screen is, for example, a display unit (not shown in drawings) included in the boundary defining system 1 itself. However, the screen may also be, for example, a touch screen of a mobile device (e.g., mobile phone). In other words, the first output process may be the processing unit 13 controlling the screen of the boundary defining system 1 to display the operating range data, or the processing unit 13 transmitting the operating range data to the mobile device to display the operating range data through the mobile device.

The processing unit 13 performs the second output process by outputting the operating range data to the storage unit 12 so that the operating range data is stored by the storage unit 12, or the processing unit 13 may also transmit the operating range data to an external server device or a mobile device for storage.

The processing unit 13 performs the third output process by transmitting the operating range data to the autonomous mobile operation equipment, so that the operating range data is stored within the autonomous mobile operation equipment. Furthermore, the autonomous mobile operation equipment can further plan an operating path located within the operating area A2 based on the operating range data, and move autonomously in the operating area A2 according to the operating path to achieve automated operations, wherein the operating path is, for example, a weeding path used for making the autonomous mobile operation equipment move back and forth in the operating area A2. It is worth mentioning that by using the operating range data to plan the operating path, the risk of the autonomous mobile operation equipment exceeding the ideal target area when moving autonomously can be greatly reduced. In addition, the processing unit 13 may also transmit the operating range data to an external server device or a mobile device, and the server device or the mobile device plans the operating path based on the operating range data.

Furthermore, in the present embodiment, the processing unit 13 outputs the operating range data by, for example, first performing the first output process, and after receiving an application confirmed command inputted by the user and corresponding to the operating range data, performing the second output process and the third output process, but is not limited thereto.

The above is an example of how the boundary defining system 1 of the present embodiment implements the operating boundary defining procedure of the boundary defining method.

It should be noted that the way in which the processing unit 13 generates the alternative path sections a3 is not limited to the present embodiment. For example, in other embodiments, for each risky path section a1, the processing unit 13 may also directly generate as the corresponding alternative path section a3 a path located within the circled area A1 and directly connecting both ends of the risky path section a1. Moreover, the track shape of each alternative path section a3 does not need to be similar to the corresponding risky path section a1. That is, each alternative path section a3 does not have to be equidistant from the corresponding risky path section a1. Generally speaking, as long as the processing unit 13 generates, for each risky path section a1, an alternative path section a3 that is more “shrunken” than the risky path section a1, and then defines an operating area A2 with an area smaller than the circled area A1, it is an implementable form of the present invention. On the other hand, as there are various ways and standards for assessing the signal strength of positioning and accuracy of positioning results, the actual form of the poor signal condition is not limited to the present embodiment.

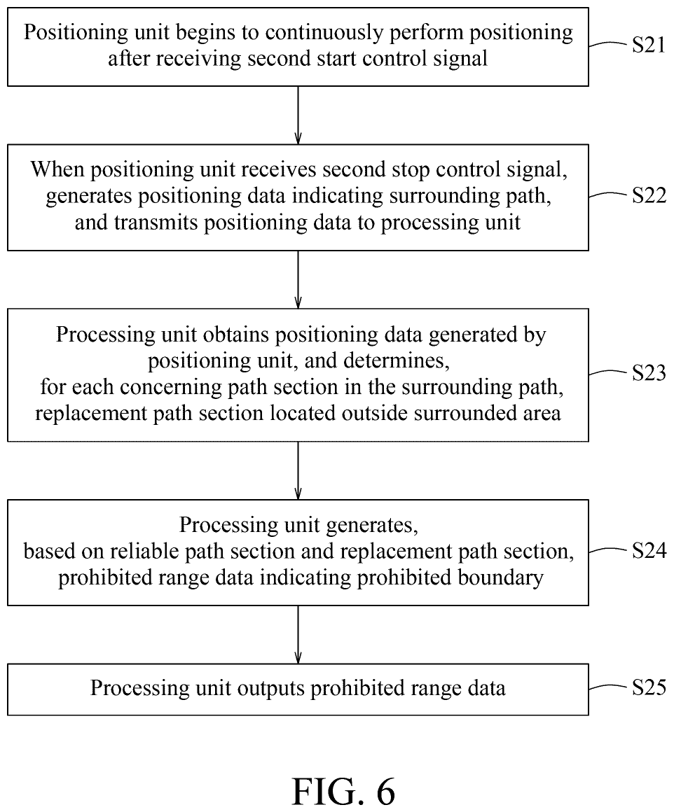

Referring to FIG. 1 and FIG. 6 at the same time, the following is a description of how the boundary defining system 1 performs the prohibited boundary defining process.

First, in step S21, when the positioning unit 11 receives a second start control signal, the positioning unit 11 begins to continuously receive a satellite signal group from the satellite navigation system 2, and continuously performs positioning (RTK positioning in the present embodiment) and records positioning results based to the satellite signal group, wherein the satellite signal group is substantially the same as the satellite signal group described in step S11 of the operating boundary defining procedure, and a description thereof will not be repeated here. On the other hand, the second start control signal is, for example, generated by the processing unit 13. More specifically, when the user wants to start operating the boundary defining system 1 to circle around the ideal exclusion area, the user can operate the boundary defining system 1 so that the processing unit 13 generates and transmits the second start control signal to the positioning unit 11, thereby controlling the positioning unit 11 to begin continuously performing positioning and recording positioning results.

As the positioning unit 11 continuously performs positioning, the process proceeds to step S22.

In step S22, when the positioning unit 11 receives a second stop control signal, the positioning unit 11 stops recording positioning results, generates another piece of positioning data based on all positioning results generated by the positioning unit 11 in step S21, and transmits the another piece of positioning data to the processing unit 13. The another piece of positioning data includes another path record and another signal status record. The another path record includes another plurality sets of positioning coordinates in sequence, and each of the sets of positioning coordinates is a positioning result generated by the positioning unit 11.

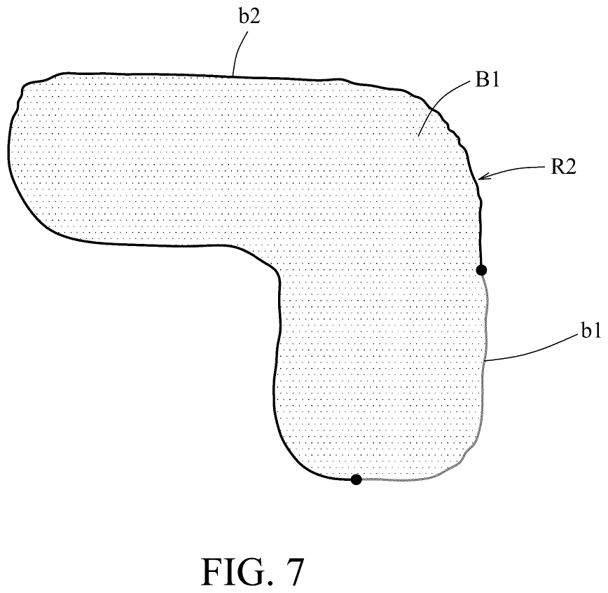

Referring to FIG. 7, the sets of positioning coordinates of the another path record jointly indicate a surrounding path R2, wherein the surrounding path R2 has a plurality of path sections, and defines a surrounded area B1. It should be noted that the positioning results of the processing unit 11 may contain errors. Therefore, the surrounded area B1 and the ideal exclusion area may not necessarily be the same.

On the other hand, another signal status record of the another piece of positioning data includes a plurality of positioning status codes respectively corresponding to the sets of positioning coordinates, and, for the path sections of the surrounding path R2, the positioning status codes jointly indicate one or more concerning path sections b1 in the path sections that meet the poor signal condition, and one or more reliable path sections b2 that “do not” meet the poor signal condition.

FIG. 7 exemplarily shows a single concerning path section b1 and a reliable path section b2, and the present embodiment is mainly described using the concerning path section b1 and the reliable path section b2 in FIG. 7. However, it should be understood that in actual implementation, depending on a positioning situation of the positioning unit 11, the surrounding path R2 may also have multiple concerning path sections b1 and multiple reliable path sections b2, and is not limited to the present embodiment.

Similar to the risky path sections a1 (shown in FIG. 3) described in the operating boundary defining procedure, the concerning path section b1 is a collection of positioning results recorded by the processing unit 11 under relatively poor accuracy conditions. Thus, there may be a large offset error between a movement path indicated by the concerning path section b1 and the actual movement path of the processing unit 11 when recording the concerning path section b1. Therefore, the concerning path section b1 may have a section that is located within the ideal exclusion area circled around by the positioning unit 11, which means that the surrounded area B1 cannot completely cover the ideal exclusion area.

In addition, the second stop control signal is, for example, generated by the processing unit 13. More specifically, when the user has operated the boundary defining system 1 to complete the circling of the ideal exclusion area, the user can operate the boundary defining system 1 so that the processing unit 13 generates and transmits the second stop control signal to the positioning unit 11, thereby controlling the positioning unit 11 to stop recording positioning results.

After the positioning unit 11 transmits the another piece of positioning data to the processing unit 13, the process proceeds to step S23.

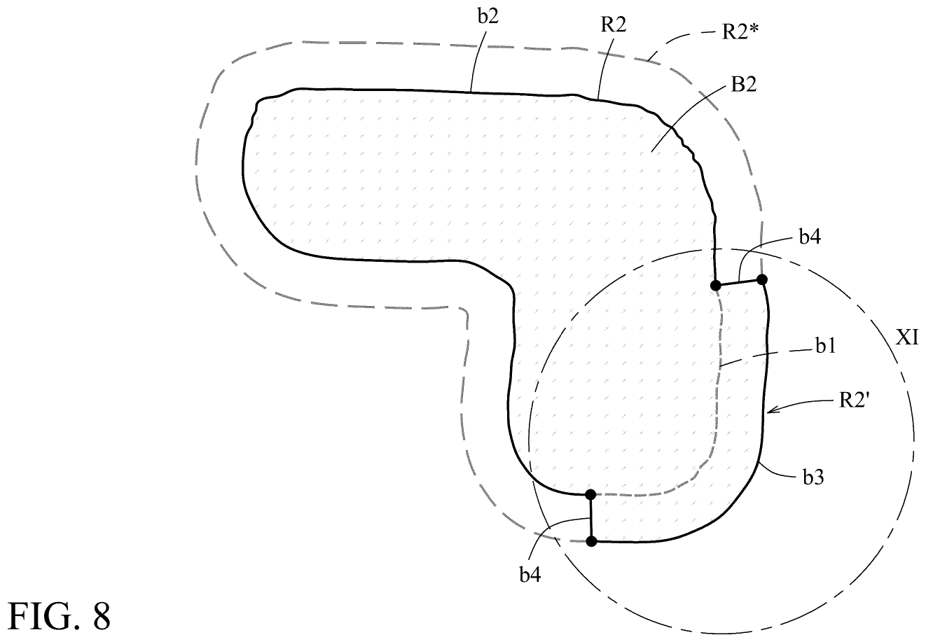

In step S23, with reference to FIG. 8, once the processing unit 13 obtains the another piece of positioning data from the positioning unit 11, for the concerning path section b1 indicated by the another signal status record, the processing unit 13 determines, based on the location of the concerning path section b1 and the predetermined outward expansion distance indicated by the outward expansion distance parameter P2, a replacement path section b3 corresponding to the concerning path section b1 and located outside the surrounded area B1. In the present embodiment, the replacement path section b3 and the concerning path section b1 are equidistantly spaced apart from each other, and a separation distance between the replacement path section b3 and the concerning path section b1 is equal to the predetermined outward expansion distance, but is not limited thereto.

More particularly, in the present embodiment, the processing unit 13, for example, first expands the surrounding path R2 according to the predetermined outward expansion distance in order to determine a hypothetical path R2″ that is located outside the surrounded area B1, that is similar in shape to the surrounding path R2, and that is equidistantly spaced apart from the surrounding path R2 by the predetermined outward expansion distance. Then, for each concerning path section b1, the processing unit 13 extracts from the hypothetical path R2″ a section corresponding to the location of the concerning path section b1 to be used as the replacement path section b3 corresponding to the concerning path section b1.

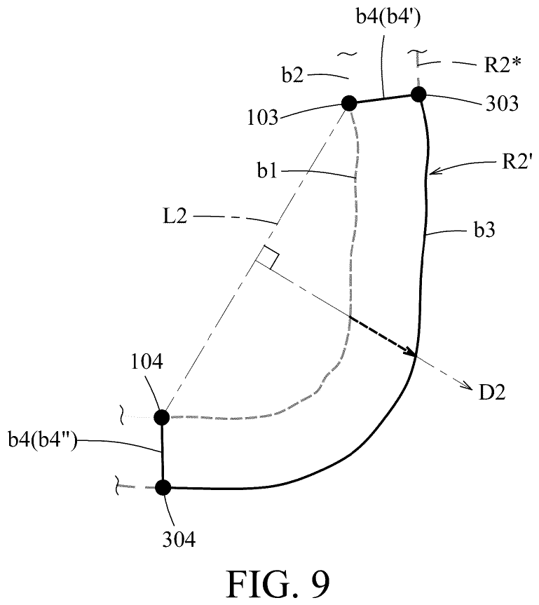

Referring to FIG. 9, the replacement path section b3 is equivalent to a result of first connecting a terminal end 103 and a terminal end 104 of the concerning path section b1 using an imaginary line L2, then shifting the concerning path section b1 by the predetermined outwards expansion distance towards an expansion direction D2 that is perpendicular to the imaginary line L2, and simultaneously proportionally enlarging a length and a width of a track shape of the concerning path section b1.

It should be added that if the surrounding path R2 has multiple concerning path sections b1, the processing unit 13 will respectively determine a plurality of corresponding replacement path sections b3 for the concerning path sections b1, and the method of determination is the same as the above description.

Referring to FIG. 1, FIG. 6 and FIG. 8 at the same time, after the processing unit 13 determines the corresponding replacement path section b3 for the concerning path section b1, the process proceeds to step S24.

In step S24, the processing unit 13 generates, based on the reliable path section b2 and the replacement path section b3, a piece of prohibited range data indicating a prohibited boundary R2′. More particularly, in the present embodiment, the processing unit 13 first determines for the replacement path section b3 two connecting path sections b4 corresponding to the replacement path section b3 so that two ends of the replacement path section b3 are each connected to the reliable path section b2 through one of the connecting path sections b4. Then, the processing unit 13 generates the prohibited range data based on all of the reliable path section b2, the replacement path section b3, and the connecting path sections b4.

Referring to FIG. 9, one connecting path section b4′ of the two connecting path sections b4 is connected between a first end 303 of the replacement path section b3 and a terminal end 103 of the reliable path section b2, wherein the terminal end 103 is also equivalent to one end of the concerning path section b1 corresponding to the replacement path section b3. On the other hand, one connecting path section b4″ of the two connecting path sections b4 is connected between a second end 304 of the replacement path section b3 and a terminal end 104 of the reliable path section b2, wherein the terminal end 103 is also equivalent to the other end of the concerning path section b1 corresponding to the replacement path section b3.

Referring again to FIG. 8, in the present embodiment, the prohibited boundary R2′ is composed of the reliable path section b2, the replacement path section b3 and the connecting path sections b4. In other words, the prohibited boundary R2′ does not include the concerning path section b1. Moreover, the prohibited boundary R2′ defines a prohibited area B2 suitable for the autonomous mobile operation equipment to automatically avoid. In other words, the prohibited area B2 is jointly defined by the reliable path section b2, the replacement path section b3 and the connecting path sections b4. However, in other embodiments, the replacement path section b3 generated by the processing unit 13 may also directly connect the terminal end 103 and the terminal end 104 in FIG. 9. That is to say, the processing unit 13 does not necessarily need to generate the connecting path sections b4. Therefore, the prohibited boundary R2′ can be implemented as long as it includes the reliable path section b2 and the replacement path section b3, and does not include the concerning path section b1.

Referring to FIG. 7 and FIG. 8 at the same time, it is worth noting that compared to the surrounding path R2, the prohibited boundary R2′ is equivalent to the result of making each concerning path section b1 in the surrounding path R2 “expand” from the surrounded area B1. Thereby, even if the concerning path section b1 causes the surrounded area B1 to fail to completely cover the ideal exclusion area (that is, a section of the ideal exclusion area is located outside the surrounded area B1), the processing unit 13 can still determine the replacement path section b3 for the concerning path section b1, which is equivalent to “expanding” the concerning path section b1 to generate the prohibited boundary R2′, whereby the risk of the prohibited area B2 failing to completely cover the ideal exclusion area will be significantly reduced compared to that of the surrounded area B1.

After the processing unit 13 generates the prohibited range data indicating the prohibited boundary R2′, the procedure proceeds to step S25.

In step S25, the processing unit 13 outputs the prohibited range data indicating the prohibited boundary R2′. Specifically, the processing unit 13 outputs the prohibited range data by, for example, performing one of a fourth output process, a fifth output process, and a sixth output process.

More specifically, the processing unit 13 performs the fourth output process by outputting the prohibited range data through the screen in a display manner. That is, the screen is made to display the prohibited range data in a graphical display manner (e.g., marking the prohibited boundary R2′ on an electronic map), so as to facilitate the user to browse the prohibited boundary R2′ and the prohibited area B2 in conjunction with the electronic map.

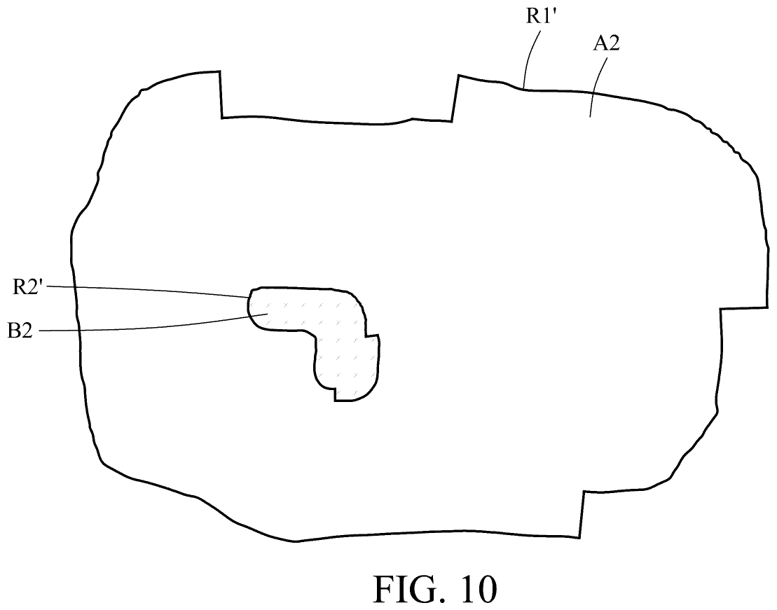

It should be noted that, assuming that the operating boundary defining procedure and the prohibited boundary defining procedure have been completed, the processing unit 13 may, for example, display through the screen the operating range data and the prohibited range data as shown in FIG. 10, so that the user can view the operating boundary R1′ and the prohibited boundary R2′ at the same time (equivalent to viewing the operating area A2 and the prohibited area B2 at the same time).

The processing unit 13 performs the fifth output process by outputting the prohibited range data to the storage unit 12 so that the prohibited range data is stored by the storage unit 12, or the processing unit 13 may also transmit the prohibited range data to an external server device or a mobile device for storage.

The processing unit 13 performs the sixth output process by transmitting the prohibited range data to the autonomous mobile operation equipment, so that the prohibited range data is stored by the autonomous mobile operation equipment. Furthermore, the autonomous mobile operation equipment can plan, based on the prohibited range data and the operating range data, an operating path located within the operating area A2 but outside the prohibited area B2, and move autonomously according to the operating path, thereby achieving automated operations in the operating area A2 under the premise of not entering the prohibited area B2. It is worth mentioning that by using the prohibited range data to plan the operating path, the risk of the autonomous mobile operation equipment entering the ideal exclusion area when moving autonomously can be greatly reduced. In addition, the processing unit 13 may also transmit the prohibited range data to an external server device or a mobile device, and the server device or the mobile device plans the operating path based on the prohibited range data.

Furthermore, in the present embodiment, the processing unit 13 outputs the prohibited range data by, for example, first performing the fourth output process, and after receiving an application confirmed command inputted by the user and corresponding to the prohibited range data, performing the fifth output process and the sixth output process, but is not limited thereto.

The above is an example of how the boundary defining system 1 of the present embodiment implements the prohibited boundary defining procedure of the boundary defining method.

It should be noted that the way in which the processing unit 13 generates the replacement path section b3 is not limited to the present embodiment. For example, in other embodiments, the processing unit 13 may also directly generate as the corresponding replacement path section b3 a path located outside the surrounded area B1 and directly connecting both ends of the concerning path section b1. Moreover, the track shape of the replacement path section b3 does not need to be similar to the corresponding concerning path section b1. That is, the replacement path section b3 does not have to be equidistant from the corresponding concerning path section b1. Generally speaking, as long as the processing unit 13 generates, for each concerning path section b1, a replacement path section b3 that is more “expanded” than the concerning path section b1, and then defines a prohibited area B2 with an area larger than the surrounded area B1, it is an implementable form of the present invention.

It should be added that step S11 to step S15, step S21 to step S25 and the flow charts in FIGS. 2 and 6 of this embodiment are only used to illustrate one of the possible implementation methods of the boundary defining system 1 of the present invention. It should be understood that even if step S11 to step S15 and step S21 to step 25 are combined, split or adjusted in sequence, if the process after combining, splitting or adjusting in sequence achieves substantially the same effect in substantially the same way as in the present embodiment, it will still be an implementable form of the present invention. Therefore, step S11 to step S15, step S21 to step S25 and the flow charts in FIGS. 2 and 6 of the present embodiment are not intended to limit the implementable scope of the present invention.

The present invention also provides a second embodiment of the boundary defining system 1. In the second embodiment, the boundary defining system 1 further includes an input unit (not shown in drawings) for manual operation by the user and electrically connected to the processing unit 13. Specifically, the input unit is implemented as, for example, one or more buttons displayed on a casing of the boundary defining device 10. However, in an implementation in which the boundary defining system 1 is implemented as a mobile electronic device, the input unit may also be implemented as a touch panel, or a combination of a touch panel and buttons.

The main different between the second embodiment and the first embodiment lies in the boundary defining method implemented by the boundary defining system 1.

Based on the boundary defining method describe in the first embodiment, the following describes differences in the boundary defining system 1 when performing the operating boundary defining procedure of the boundary defining method in the second embodiment.

Referring to FIG. 1, FIG. 2 and FIG. 4 at the same time, in step S13 of the second embodiment, the processing unit 13 further makes each section of a plurality of sections of the circling path R1 that meets a specified correction condition serve as a specified to-be-corrected path section, and determines, based on each specified to-be-corrected path section, a self-correcting path section (not shown in drawings) corresponding to the specified to-be-corrected path section and located within the circled area A1, wherein each specified to-be-corrected path section indicates that the user has specified, based on the user's own judgement, a section of the circling path R1 to be shrunk. On the other hand, each self-correcting path section is the result of the processing unit 13 shrinking inwardly a corresponding specified to-be-corrected path section.

More specifically, each section of the circling path R1 is composed of a plurality sets of positioning coordinates generated by the positioning unit 11, and for each section of the circling path R1, the specified correction condition means that the processing unit 13 has received, during a period of time when the section is positioned by the positioning unit 11 (i.e., a period of time during a positioning process of the positioning unit 11 in step S11, such as 10 seconds of a positioning period), a specified correction command generated based on manual operation of the user. More particularly, the specified correction command is generated and outputted to the processing unit 13 by the input unit according to manual operation (such as a long press operation or a click operation) of the user. In other words, the user can freely operate the input unit to generate and output the specified correction command during the process of operating the boundary defining system 1 to circle around the ideal target area, thereby specifying the section in the circling path R1 to be shrunk inward.

Furthermore, in step S14 of the second embodiment, the processing unit 13 generates, based on the safe path sections a2, the alternative path sections a3 and the self-correcting path section(s), the operating range data indicating the operating boundary R1′. In other words, in the second embodiment, the operating boundary R1′ includes the safe path sections a2, the alternative path sections a3, the connecting path sections a4 and the self-correcting path section(s), and does not include any risky path sections a1 or specified to-be-corrected path section.

It should be added that the processing unit 13 may determine, for each self-correcting path section, two connecting path sections corresponding to the self-correcting path section, so that two ends of the self-correcting path section are each connected to one of the safe path sections a2 through one of the connecting path sections, similar to the way the processing unit 13 makes each alternative path section a3 and safe path section a2 connect to each other.

In addition, a separation distance between each self-correcting path and the corresponding specified to-be-corrected path section may be the same as or different from the predetermined inward shrinkage distance indicated by the inward shrinkage distance parameter P1.

The above is a description of the operating boundary defining procedure in the second embodiment.

Based on the boundary defining method described in the first embodiment, the following describes differences in the boundary defining system 1 when performing the prohibited boundary defining procedure of the boundary defining method in the second embodiment.

Referring to FIG. 1, FIG. 6 and FIG. 8 at the same time, in step S23 of the second embodiment, the processing unit 13 further makes each section of a plurality of sections of the surrounding path R2 that meets a specified adjustment condition serve as a specified to-be-adjusted path section, and determines, based on each specified to-be-adjusted path section, a self-adjusting path section (not shown in drawings) corresponding to the specified to-be-adjusted path section and located outside the surrounded area B1, wherein each specified to-be-adjusted path section indicates that the user has specified, based on the user's own judgement, a section of the surrounding path R2 to be expanded. On the other hand, each self-adjusting path section is the result of the processing unit 13 expanding outwardly a corresponding specified to-be-adjusted path section.

More specifically, each section of the surrounding path R2 is composed of a plurality sets of positioning coordinates generated by the positioning unit 11, and for each section of the surrounding path R2, the specified adjustment condition means that the processing unit 13 has received, during a period of time when the section is positioned by the positioning unit 11 (i.e., a period of time during a positioning process of the positioning unit 11 in step S21, such as 10 seconds of a positioning period), a specified adjustment command generated based on manual operation of the user. More particularly, the specified adjustment command is generated and outputted to the processing unit 13 by the input unit according to manual operation (such as a long press operation or a click operation) of the user. In other words, the user can freely operate the input unit to generate and output the specified adjustment command during the process of operating the boundary defining system 1 to circle around the ideal exclusion area, thereby specifying the section in the surrounding path R2 to be expanded outwardly.

Furthermore, in step S24 of the second embodiment, the processing unit 13 generates, based on the reliable path section(s) b2, the replacement path section(s) b3 and the self-adjusting path section(s), the prohibited range data indicating the prohibited boundary R2′. In other words, in the second embodiment, the prohibited boundary R2′ includes the reliable path section(s) b2, the replacement path section(s) b3 and the self-adjusting path section(s), and does not include any concerning path sections b1 or specified to-be-adjusted path section.

It should be added that the processing unit 13 may determine, for each self-adjusting path section, two connecting path sections corresponding to the self-adjusting path section, so that two ends of the self-adjusting path section are each connected to one of the reliable path sections b2 through one of the connecting path sections, similar to the way the processing unit 13 makes each replacement path section b3 and reliable path section b2 connect to each other. In addition, a separation distance between each self-adjusting path and the corresponding specified to-be-adjusted path section may be the same as or different from the predetermined outward expansion distance indicated by the outward expansion distance parameter P2.

The above is a description of the prohibited boundary defining procedure in the second embodiment.

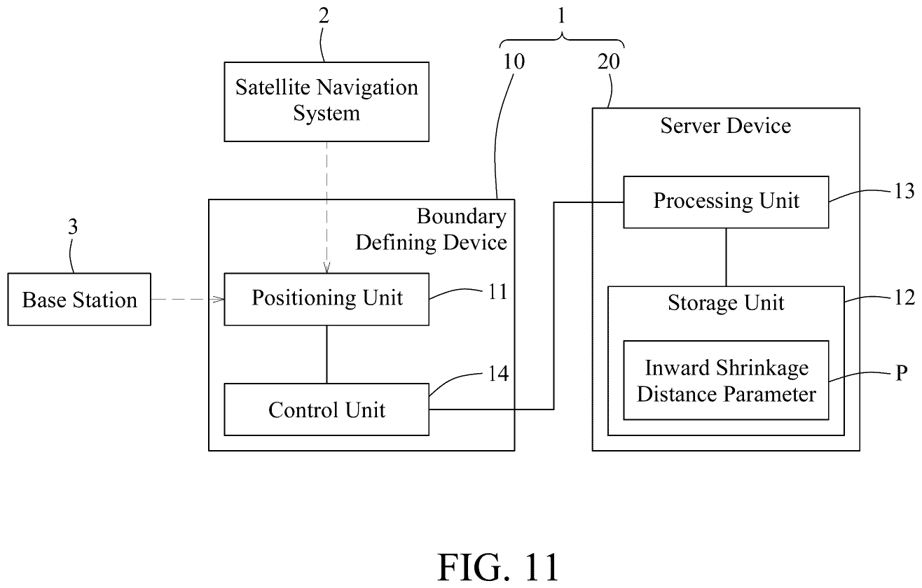

Referring to FIG. 11, in a third embodiment of the boundary defining system 1 of the present invention, what is different from the first embodiment is that the boundary defining system 1 includes a boundary defining device 10 and a server device 20, wherein the positioning unit 11 is included in the boundary defining device 10, and the storage unit 12 and the processing unit 13 are included in the server device 20. The boundary defining device 10 further includes a control unit 14 directly electrically connected to the positioning unit 11, wherein the control unit 14 includes a processor, and can intercommunicate with the processing unit 13 via a wireless connection through a network.

In a fourth embodiment of the boundary defining system 1 of the present invention, the boundary defining system 1 is implemented as an autonomous mobile operation equipment with specific operation functions (such as, but not limited to, weeding). In other words, the boundary defining system 1 in this embodiment is an AMR with a built-in boundary defining function. Moreover, in this embodiment, the processing unit 13, after generating and outputting the operating range data (and the prohibited range data), for example, further plans an operating path located within the operating area A2 (and located the prohibited area B2) based on the operating range data (and the prohibited range data), and controls the autonomous mobile operation equipment to move autonomously in the operating area A2 according to the operating path to achieve automated operations.

In a fifth embodiment of the boundary defining system 1 of the present invention, the boundary defining system 1 is implemented as a mobile electronic device that can be carried by the user. More particularly, the mobile electronic device can actually be a smartphone, a tablet computer or a laptop computer.

In a sixth embodiment of the boundary defining system 1 of the present invention, the boundary defining system 1 includes a mobile electronic device and a server device, wherein the positioning unit 11 is included in the mobile electronic device, and the storage unit 12 and the processing unit 13 are included in the server device. Moreover, the mobile electronic device further includes a control unit directly electrically connected to the positioning unit 11. The control unit includes a processor, and can intercommunicate with the processing unit 13 via wireless connection through a network, thereby providing to the processing unit 13 positioning data generated by the positioning unit 11.

The present invention also provides an embodiment of a computer program product. The computer program product includes an application program, and the application program can be stored on a computer-readable recording medium. More specifically, the application program can be transmitted to an electronic device (such as, but not limited to, a smartphone, a tablet computer, a laptop computer or an autonomous mobile operation equipment) that includes the positioning unit 11, the storage unit 12 and the processing unit 13, and thereby be stored in the storage unit 12 of the electronic device. Furthermore, the application program can be loaded and run on the processing unit 13, and when the processing unit 13 of the electronic device loads and runs the application program of the computer program product, the application program can enable the electronic device to be used as the boundary defining system 1, and enable the electronic device to implement the boundary defining method of any of the aforementioned implementations.

In summary, by implementing the operating boundary defining procedure of the boundary defining method, the positioning unit 11 can not only, under the control of the processing unit 13, generate the path record indicating the circling path R1, but also generate the signal status record indicating each risky path section a1. Moreover, after obtaining the path record and the signal status record, the processing unit 13 can determine the corresponding alternative path section a3 based on each risky path section a1 indicated by the signal status record, and then replace the corresponding risky path section a1 with each alternative path section a3 to generate operating range data indicating the operating boundary R1′, thereby defining the operating area A2 applicable to the autonomous mobile operation equipment. It is worth mentioning that the operating boundary R1′ is equivalent to the result of “shrinking inwardly” each risky path section a1 of the circling path R1 toward the circled area A1. Thereby, even if a part of the circled area A1 exceeds the ideal target area circled around by the positioning unit 11, the processing unit 13 can still generate the operating boundary R1′ that is equivalent to “shrinking inwardly” the risky path sections a1 to define the operating area A2 so that the risk of the operating area A2 exceeding the ideal target area is significantly lower than that of the circled area A1. In this way, if the operating boundary R1′ indicated by the operating range data is used to plan an operating path for the autonomous mobile operation equipment, the autonomous mobile operation equipment exceeding the ideal target area due to errors in the circling path R1 itself can be effectively prevented.

On the other hand, by implementing the prohibited boundary defining procedure of the boundary defining method, the positioning unit 11 can not only, under the control of the processing unit 13, generate the path record indicating the surrounding path R2, but also generate the signal status record indicating each concerning path section b1. Moreover, after obtaining the path record and the signal status record, the processing unit 13 can determine the corresponding replacement path section b3 based on each concerning path section b1 indicated by the signal status record, and then replace the corresponding concerning path section b1 with each replacement path section b3 to generate prohibited range data indicating the prohibited boundary R2′, thereby defining the prohibited area B2 applicable to the autonomous mobile operation equipment. It is worth mentioning that the prohibited boundary R2′ is equivalent to the result of “expanding outwardly” from the surrounded area B1 each of the concerning path sections b1 of the surrounding path R2. Thereby, even if a part of the surrounded area B1 cannot completely cover the ideal exclusion area, the processing unit 13 can still generate the prohibited boundary R2′ that is equivalent to “expanding outwardly” the concerning path sections b1 to define the prohibited area B2 so that the risk of the prohibited area B2 failing to completely cover the ideal exclusion area is significantly lower than that of the surrounded area B1. In this way, if the prohibited boundary R2′ indicated by the prohibited range data is used to plan an operating path for the autonomous mobile operation equipment, the autonomous mobile operation equipment entering the ideal exclusion area due to errors in the surrounding path R2 itself can be effectively prevented. Therefore, the object of the present invention can indeed be achieved.

However, the above are merely embodiments of the present invention, and certainly, the scope of the present invention in practice cannot be limited thereby. Any simple equivalent variation and modification made according to the claims of the present invention and the contents of patent specification should fall within the scope covered by a patent to the present invention.

1. A boundary defining method, to be implemented by a boundary defining system that includes a positioning unit and a processing unit; the boundary defining method comprising:
(A) the processing unit obtaining a piece of positioning data generated by the positioning unit performing positioning according to a satellite signal group, wherein the piece of positioning data includes a path record and a signal status record, the path record indicates a circling path defining a circled area, and the signal status record indicates one or more risky path sections in the circling path that meet a poor signal condition;
(B) the processing unit, based on each risky path section indicated by the signal status record, determining an alternative path section corresponding to the risky path section and located within the circled area; and
(C) the processing unit, based on at least the alternative path section(s), generating and outputting a piece of operating range data indicating an operating boundary, wherein the operating boundary defines an operating area suitable for automatic movement of an autonomous mobile operation equipment, and that does not include the risky path section(s).

2. The boundary defining method as claimed in claim 1, wherein in step (A), the positioning unit uses Real Time Kinematic (RTK) to perform positioning to generate the piece of positioning data, the satellite signal group includes one or more satellite signals from a satellite navigation system, and the poor signal condition is related to a quantity of the satellite signals.

3. The boundary defining method as claimed in claim 1, wherein in step (B), for each risky path section, the processing unit determining the alternative path section corresponding to the risky path section is based on a location of the risky path section and a predetermined inward shrinkage distance, and the predetermined inward shrinkage distance is related to a separation distance between the risky path section and the alternative path section corresponding to the risky path section.

4. The boundary defining method as claimed in claim 1, wherein in step (B), each alternative path section and the risky path section corresponding to the alternative path section are spaced apart from each other.

5. The boundary defining method as claimed in claim 1, wherein
in step (B), the processing unit further makes each section of a plurality of sections of the circling path that meets a specified correction condition serve as a specified to-be-corrected path section, and determines, based on each specified to-be-corrected path section, a self-correcting path section corresponding to the specified to-be-corrected path section and located within the circled area, wherein for each section of the circling path, the specified correction condition indicates that the processing unit has received, during a period of time when the section is positioned by the positioning unit, a specified correction command generated based on manual operation of a user,
in step (C), the processing unit generating the piece of operating range data is based on at least the alternative path section(s) and the self-correcting path section(s), and the operating boundary indicated by the piece of operating range data does not include the risky path section(s) and the specified to-be-corrected path section(s).

6. A boundary defining method, to be implemented by a boundary defining system that includes a positioning unit and a processing unit; the boundary defining method comprising:
(A) the processing unit obtaining a piece of positioning data generated by the positioning unit performing positioning according to a satellite signal group, wherein the piece of positioning data includes a path record and a signal status record, the path record indicates a surrounding path defining a surrounded area, and the signal status record indicates one or more concerning path sections in the surrounding path that meet a poor signal condition;
(B) the processing unit, based on each concerning path section indicated by the signal status record, determining a replacement path section corresponding to the concerning path section and located outside the surrounded area; and
(C) the processing unit, based on at least the replacement path section(s), generating and outputting a piece of prohibited range data indicating a prohibited boundary, wherein the prohibited boundary defines a prohibited area for prohibiting an autonomous mobile operation equipment from entering automatically, and does not include the concerning path section(s).

7. The boundary defining method as claimed in claim 6, wherein in step (A), the positioning unit uses Real Time Kinematic (RTK) to perform positioning to generate the piece of positioning data, the satellite signal group includes one or more satellite signals from a satellite navigation system, and the poor signal condition is related to a quantity of the satellite signals.

8. The boundary defining method as claimed in claim 6, wherein in step (B), for each concerning path section, the processing unit determining the replacement path section corresponding to the concerning path section is based on a location of the concerning path section and a predetermined outward expansion distance, and the predetermined outward expansion distance is related to a separation distance between the concerning path section and the replacement path section corresponding to the concerning path section.

9. The boundary defining method as claimed in claim 6, wherein in step (B), each replacement path section and the concerning path section corresponding to the replacement path section are spaced apart from each other.

10. The boundary defining method as claimed in claim 6, wherein
in step (B), the processing unit further makes each section of a plurality of sections of the surrounding path that meets a specified adjustment condition serve as a specified to-be-adjusted path section, and determines, based on each specified to-be-adjusted path section, a self-adjusting path section corresponding to the specified to-be-adjusted path section and located outside the surrounded area, wherein for each section of the surrounding path, the specified adjustment condition indicates that the processing unit has received, during a period of time when the section is positioned by the positioning unit, a specified adjustment command generated based on manual operation of a user,
in step (C), the processing unit generating the piece of prohibited range data is based on at least the replacement path section(s) and the self-adjusting path section(s), and the prohibited boundary indicated by the piece of prohibited range data does not include the concerning path section(s) and the specified to-be-adjusted path section(s).

11. A boundary defining system comprising:
a positioning unit used for performing positioning according to satellite signals; and
a processing unit electrically connected to said positioning unit, and configured to implement the boundary defining method as claimed in claim 1.

12. A computer program product comprising an application program, wherein, when the application program is loaded and run on an electronic device that includes a positioning unit and a processing unit, the application program can enable the electronic device to implement the boundary defining method as claimed in claim 1.

13. A boundary defining system comprising a positioning unit used to perform positioning according to satellite signals; and a processing unit electrically connected to said positioning unit, and configured to implement the boundary defining method as claimed in claim 6.

14. A computer program product comprising an application program, wherein, when the application program is loaded and run on an electronic device that includes a positioning unit and a processing unit, the application program can enable the electronic device to implement the boundary defining method as claimed in claim 6.
